(19) United States
(12) Patent Application Publication
(10) Pub. No.: US 2012/0279121 A1
(43) Pub. Date: Nov. 8, 2012

(54) Apparatus for influencing the growth of a plant

(75) Inventors: Rob Franciscus Maria Van Elmpt, Roermond (NL); Cristina Tanase, Waalre (NL); Henricus Marie Peeters, Baarlo (NL)

(73) Assignee: KONINKLIJKE PHILLIPS ELECTRONICS,. N.V., Eindhoven (NL)

(21) Appl. No.: 13/520,360

(22) PCT Filed: Jan. 11, 2011
(86) PCT No.: PCT/IB11/50106

§ 371 Date: Jul. 3, 2012

(30) Foreign Application Priority Data
Jan. 14, 2010 (EP) 10150701.,0

(51) Int. Cl. A01G 7/00

(52) U.S. Cl. 47/58.1 LS

(57) ABSTRACT

Disclosed is a multistage thermal convection apparatus such as a two-stage thermal convection apparatus and uses thereof. In one embodiment, the two-stage thermal convection apparatus includes a temperature shaping element that assists a thermal convection mediated Polymerase Chain Reaction (PCR). The invention has a wide variety of applications including amplifying nucleic acid without cumbersome and expensive hardware associated with many prior devices. In a typical embodiment, the apparatus can fit in the palm of a user's hand for use as a portable, simple to operate, and low cost PCR amplification device.

### FIELD OF THE INVENTION

The present invention relates to an apparatus and a method for influencing the growth of plants.

### BACKGROUND OF THE INVENTION

In many situations the growth of plants is negatively affected by less than optimal climatic and lighting conditions, for example grass on sport fields is often exposed to dark and closed conditions and it also has to stand a high amount of wear. Further, in order to be able to use e.g. a sport field as often as possible, due to practical and economic reasons, the grass has to recover fast, which forms a contrast to the above-mentioned less than optimal conditions. One alternative would be to replace damaged parts of the grass but this is expensive and time consuming, especially if major parts of a sport field have to be exchanged. To overcome this problem it has been suggested to treat the surface of a sport field by providing better conditions with artificial light of suitable wavelengths, favorable temperature and carbon dioxide, thereby increasing the growth rate of the grass. Such a solution is presented in WO2006/054899. In that prior art a tarp is provided with LEDs on its underside. When the tarp is to be used, it has to be rolled out over a part of a sport field and an air pressure is provided so that the tarp floats above the surface of the sport field with the LEDs directed downwards.

The solution in that prior art has, however, the disadvantage that even if only a small part of a field needs to be treated the tarp has to be rolled out in its full width and, depending on the position of the area to be treated, sometimes also in its full length. As a result of this, the whole tarp may have to be pressurized irrespective of the size of the damaged surface. Thus, there is a need for an alternative solution which provides for a higher degree of flexibility.

### SUMMARY OF THE INVENTION

It is an object of the present invention to overcome at least the problem mentioned above.

According to a first aspect of the invention, this and other objects are achieved by an apparatus for influencing the growth of a plant. The apparatus comprises a mobile carriage, a light source and a fuel cell, wherein the light source and the fuel cell are mounted to the mobile carriage. The light source is driven by power produced by the fuel cell, and in an operative state of the apparatus light emitted by the light source and a reaction product from the fuel cell are directed towards the plant.

The present invention is based on the realization that by combining a mobile carriage with a fuel cell as power source a very high degree of flexibility and mobility can be achieved. An apparatus according to the invention can be positioned at an arbitrary position without having to consider any cables, hoses or the like. Another advantage with the apparatus according to the invention is that reaction products of the fuel cell in fact can be used to further improve the efficiency of the apparatus. Examples of reaction products from fuel cells are carbon dioxide, heat and water, all of which can be used to improve growth of plants, especially in combination with higher light levels.

In accordance with an embodiment of the apparatus, a reaction product of the fuel cell is carbon dioxide. High concentrations of carbon dioxide significantly increase growth of plants.

In accordance with an embodiment of the apparatus the light source comprises a light emitting diode (LED). The use of LEDs has a number of advantages in this area. They have low energy consumption, a high degree of efficiency and by using a plurality of LEDs the possibility of combining different colors is provided. Further, LEDs show very favorable start-up and functional behavior in a wide range of climates, especially in cold environments. The combination of a fuel cell as power generator and a LED as light source is most convenient since fuel cells generate low voltage DC power and LEDs operate on low voltage DC power which makes power conversion steps simple, cheap and efficient. LEDs produce no radiated heat and can therefore be placed close to the plants unlike conventional light sources.

In accordance with an embodiment of the apparatus, the fuel cell is selected from the group consisting of Direct Methanol Fuel Cell, Formic Acid Fuel Cell, Formaldehyde fuel cell and Ethanol Fuel Cell. Each of these fuel cells produces power by converting the respective fuel and oxygen into carbon dioxide and water and features a number of advantages when used for this purpose. They have high power generating efficiency, small size, can run over extended periods of time and can be refueled in a fast and easy manner. Another very convenient circumstance with these fuel cells when used in this field is that all reaction products, namely electricity, carbon dioxide, water and heat, arising from such fuel cells can be used to influence the growth of plants.

In accordance with an embodiment of the apparatus, an electric drive system powered by the fuel cell and a steering device is provided. By providing the apparatus with one or more electric motors, the apparatus can be made self-propelled. As with LEDs, an electric drive system is suitable in combination with a fuel cell as power source due to the fact that such electric drive system can run on low voltage DC power.

In accordance with an embodiment of the apparatus, a control unit is provided at the apparatus. By continuously controlling the apparatus, the environment of the plant and the plant itself, the efficiency of the apparatus can be enhanced.

In accordance with an embodiment of the apparatus, the control unit comprises a position indicator for determining the position of the apparatus. This makes it possible to employ the apparatus at predetermined specific positions. Instead of treating a complete sports field, only the sections that need repair are treated, for instance the area in front of the goals of a football field.

In accordance with an embodiment of the apparatus, the position indicator comprises a global positioning system (GPS) module. A GPS-module constitutes an inexpensive and reliable solution for outdoor use.

In accordance with an embodiment of the apparatus, the position indicator comprises a local positioning module. In environments where a GPS-module cannot be used, e.g. indoors, a local positioning system can be used. Such system can use Wi-Fi technology, Infrared light, Ultra wide band radio technology or similar to determine the position of the apparatus.

In accordance with an embodiment of the apparatus a skirt is provided, wherein said skirt and an under side of the carriage are arranged to enclose a plant to be influenced. By creating a more or less closed space above the plant to be treated, the carbon dioxide concentration can be kept at a desired level, which affects the photosynthesis of the plant. The skirt can also facilitate the maintenance of other parameters such as oxygen level, temperature and air humidity within this space.

According to a further aspect of the present invention, a method for influencing the growth of a plant is provided. The method comprises the steps of providing an apparatus comprising a mobile carriage having a light source and a fuel cell mounted thereon. The light source is driven with power produced by the fuel cell and the light emitted by the light source and a reaction product of the fuel cell are directed towards the plant. By combining a mobile carriage with a fuel cell as power source a very high degree of flexibility and mobility can be achieved. An apparatus according to the invention can be positioned at an arbitrary position without having to consider any cables, hoses or similar.

In accordance with an embodiment of the method, a reaction product directed towards the plant is selected from the group consisting of carbon dioxide, heat and water. High levels of carbon dioxide in the air can be advantageous for the growth of plants. In cold climates, added heat can help plants grow faster and in dry conditions, water can be supplied to the plant to improve growth.

In accordance with an embodiment of the method, a skirt 13 is provided to the apparatus 1, wherein said skirt 13 and an under side of the mobile carriage 7 encloses a plant 2 to be influenced. By creating a more or less closed space above the plant 2 to be treated, the carbon dioxide concentration can be kept at a desired level, which affects the photosynthesis of the plant 2. The skirt 13 can also facilitate the maintenance of other parameters such as oxygen level, temperature and air humidity within this space.

In accordance with an embodiment of the method, oxygen is extracted from the vicinity of the plant 2. Low levels of oxygen in the air increases the growth of plants.

In accordance with an embodiment of the method, the levels of oxygen, carbon dioxide and water vapour are controlled independently. By controlling these parameters independently, optimal growing conditions for different types of plants can be created.

It is noted that the invention relates to all possible combinations of features recited in the claims.

### BRIEF DESCRIPTION OF THE DRAWINGS

This and other aspects of the present invention will now be described in more detail, with reference to the appended drawing showing an embodiment of the invention.

FIG. 1 shows a diagrammatical cross-sectional side view of an embodiment of a lighting device according to the present inventive concept.

FIG. 2 shows a diagrammatical cross-sectional view of a fuel cell as used in an embodiment of a lighting device according to the present inventive concept.

### DETAILED DESCRIPTION

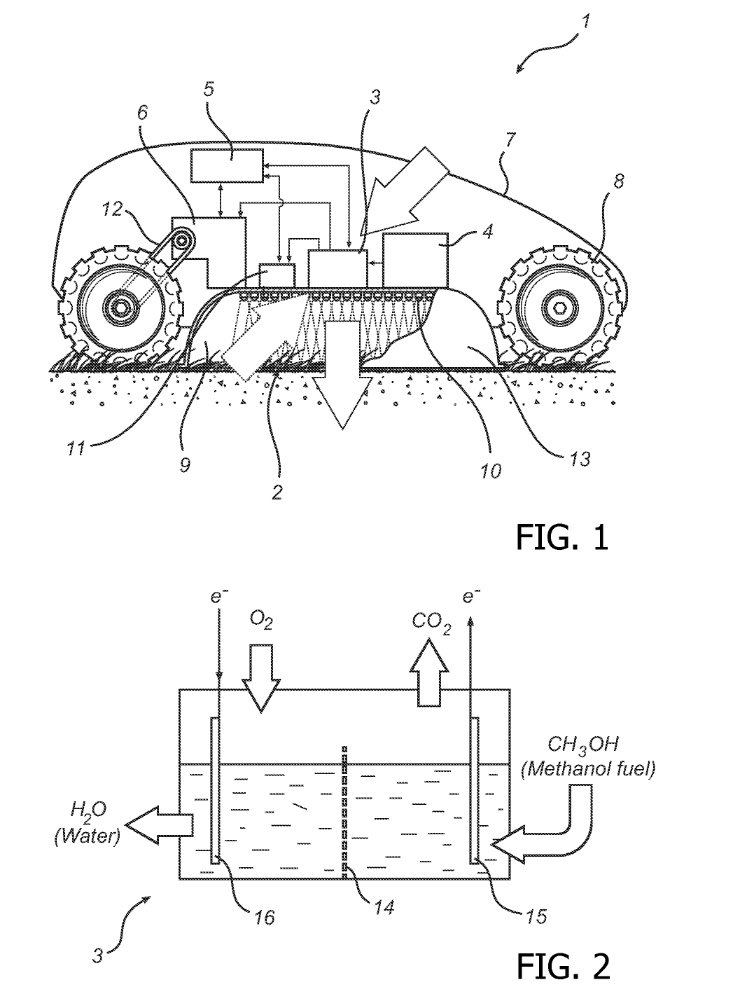

FIG. 1 shows an apparatus 1 in accordance with an embodiment of the present invention. The apparatus 1 comprises a mobile carriage 7 onto which a Direct Methanol Fuel Cell, from now on DMFC 3, is mounted together with an associated fuel tank 4. Light sources, which in this case comprises LEDs 10, are attached to an under side of the carriage 7. The DMFC 3 and the LEDs 10 are arranged such that light emitted by the LEDs 10 and reaction products, such as carbon dioxide, water and heat, of the DMFC 3 will be directed towards a plant 2. LEDs 10 are very convenient in this type of applications since they can be designed to emit light of an intended color without the use of color filters that may be necessary with other light sources. The apparatus 1 further comprises a LED driver 11 providing a constant current power supply to avoid damaging or even destroying of the LEDs 10. An electric drive system 6 is provided to enable the apparatus 1 to move to the required positions of e.g. a sports field. As is the case with the light sources, the electric drive system 6 is also powered by the DMFC 3. Further, a control unit 5 is connected to the light sources, the electric drive system 6 and the DMFC 3 in order to monitor and control the function of the apparatus 1. Furthermore, the apparatus 1 comprises a skirt 13 arranged so that a space, or treatment chamber 9, is created on an under side of the apparatus 1, enclosing the plant 2 to be influenced. The skirt 13 helps sealing off the treatment compartment against ambient air in order to maintain an optimal growth climate for a plant 2 within the treatment chamber 9. The skirt 13 can be made from e.g. fabric, rigid or non-rigid plastic, metal, composite materials or any other suitable material. The main point is that a sealed off compartment is created, and for some fields of application a flexible skirt 13 is preferable and for other a rigid one might be more suitable.

The carriage 7 comprises a chassis, a casing and a number of wheels 8. The chassis acts as a mounting plate for most of the equipment of the apparatus 1 and can comprise for example a tubular frame, a sandwich construction or any other structure suitable for a chassis of this type. Depending on the intended use, the apparatus 1 will be able to cover and treat up to 10 m² at once and the chassis will have a size corresponding to that. The chassis will also provide wheel retainers. This can involve everything from a rigid wheel axle to a more sophisticated wheel suspension system. Some of these wheel retainers may also be arranged to allow the wheels 8 to change the direction in which the apparatus 1 move. Depending on the intended use, other solutions than wheels 8 can be of interest, for example caterpillar tracks. The casing is provided in order to protect the equipment of the apparatus 1 against rain etc.

The use of a DMFC for an apparatus for influencing the growth of plant has many advantages. When compared to wired applications, the main advantage is the unhindered mobility of the apparatus according to the present invention. With an on-board DMFC there are no cables limiting the range of action of the apparatus 1, and cables are prone to get entangled which may cause operations disturbance. It would be possible to power a generator with a normal combustion engine in order to avoid cables. Combustion engines are however rather heavy and bulky and often an exhaust gas filter system would have to be provided to deal with the toxic exhaust fumes generated by the combustion engine. Batteries, preferably rechargeable would be another way of avoiding cables. The main disadvantage with that solution is the limited capacity of the batteries and the fact that they require much time for recharging. Further, batteries are heavy and bulky. Using a hydrogen fuel cell would also be an option but the handling of such an arrangement involving hydrogen canisters is costly and dangerous.

Due to the above-mentioned reasons, a DMFC 3 is very well suited for use in an apparatus 1 for influencing the growth of a plant 2. Only the DMFC 3 will be discussed here, referring also to FIG. 2, but fuel cells running on other fuels can be applied similarly, such as Formic Acid Fuel Cells, Direct Ethanol Fuel Cells or fuel cells operating on formaldehyde.

The similarities between these different types of fuel cells become apparent when the overall reactions are envisaged:
Methanol: 2CH₃OH+3O₂→2CO₂+4H₂O
Formic acid: 2HCOOH+2O₂→2CO₂+2H₂O
Formaldehyde: CH₂O+O₂→CO₂+H₂O
Ethanol: C₂H₅OH+3O₂→2CO₂+3H₂O

In all four fuel cells the respective fuel reacts with oxygen and electricity, carbon dioxide and water is produced.

The DMFC 3 generates power through a chemical reaction between methanol and oxygen. The reaction generates carbon dioxide, water and electrons that travel through an external circuit as the electric output of the fuel cell. Referring now to FIG. 2, the principle of the DMFC 3 will be discussed. A DMFC 3 comprises an anode 15, a cathode 16 and a semi-permeable membrane 14 which blocks methanol but through which protons can be transported. Methanol is oxidized at the anode 15 and carbon dioxide is formed. Protons are transported through the semi-permeable membrane 14 to the cathode 16 where they react with oxygen to produce water. Electrons e⁻ are transported through an external circuit from anode 15 to cathode 16, providing power to connected devices. If current flows from anode 16 to cathode 15, because energy is needed for the apparatus, the reaction takes place and methanol is used up. If no energy is needed from the fuel cell the reaction simply stops. This is very unlike a combustion engine in combination with a generator. The combustion engine either has to be in operation or be switched off if no electrical power is needed.

A DMFC 3 has a high generating efficiency that comes from converting chemical energy directly into electrical energy, and, due to the comparatively small size, it provides for a versatile and persistent power source Methanol as fuel has a high energy density in terms of J/Kg or J/m³ and refueling is quick and safe. Further, methanol can be derived from mineral oil as well as from renewable energy sources and therefore availability is no problem. An important matter of fact is that all reaction products of the DMFC 3 can be used in an apparatus 1 for influencing the growth of a plant 2. The electricity produced in the fuel cell can be used to power the light sources, the electric drive system 6, the control unit 5 as well as any other peripheral equipment. The carbon dioxide can be directed towards the plant 2 in order to improve growth of the plant 2. It is well known that air containing elevated levels of carbon dioxide compared to ambient air improves the growth of plants. The skirt 13 acts as a sealing and helps maintaining the amount of carbon dioxide in the air within the space underneath the apparatus 1 on an elevated level to accelerate the growth of the plant 2. Other reaction products, such as heat and water, or humid air, can also be used to influence the growth of a plant 2. The water produced by the DMFC 3 can be used to, in a first step, cool the light sources of the apparatus 1 and, in a second step, water the plant 2. Since both a low oxygen level and a high carbon dioxide level increases the photosynthesis of a plant, it is possible to provide oxygen to the DMFC 3 from the treatment chamber 9, thereby reducing the oxygen level in the treatment chamber 9. Oxygen levels and carbon dioxide levels can be controlled independently because the reaction involving oxygen and the reaction involving carbon dioxide take place in different compartments of the fuel cell as can be seen in FIG. 2. The use of a DMFC 3 together with LEDs 10 as light sources is convenient since they both operate on low voltage DC power. The same goes for electric motors used in the electric drive system 6. All other associated equipment, control unit 5, positioning system etc., can also run on low voltage DC power. This makes power conversion steps simple, cheap, and efficient.

LEDs have properties that make them well suited as light sources in an apparatus 1 for influencing the growth of a plant 2. They have low energy consumption, good efficiency, and they can be designed to emit many different colors without the use of color filters. Further, they have very good start up and functioning behavior in all climates, also in very cold climates. The fact that LEDs can be provided that emit different colors is convenient since different treatments of plants requires light of different colors, i.e. wave lengths. Most important is the PAR-spectrum (Photosynthetic Active Radiation), the light between 700 nm and 400 nm is important for the photosynthesis of plants. Also the amount of blue light plays a role in the opening of the stomata of plants, but also influences the plants morphology. Further, in order to treat or prevent fungal infections, a light source capable of emitting UV-light, e.g. a UV-LED, is advantageous. Another example is treatment for blossom induction or germination in horticulture where light sources capable of emitting red and/or far red light are essential, which is also possible with LEDs.

The apparatus 1 contains a plurality of tunable LEDs 10 combining LEDs 10 that emit light of different wavelengths and wherein the intensity of the emitted light can be adjusted to different needs. Of course, there are other light sources that are capable of emitting light of these desired wavelengths and which can be used in an apparatus 1 for influencing the growth of a plant 2 as well. For example, a mercury lamp can emit UV-light.

The electric drive system 6 comprises an electric motor powered by the DMFC 3 and a gearing arrangement 12 for transmitting the energy released by the electric motor to e.g. one or more of the wheels 8 of the apparatus 1 or other driving arrangement such that the apparatus 1 can move over a surface. The gearing arrangement 12 can comprise a belt drive, a chain drive, a shaft drive or similar. The steering of the apparatus 1 can be achieved either by providing a steering coupling to one or more of the wheels 8 or by forcing different drive wheels 8 to rotate with different speeds.

The control unit 5 comprises a plurality of sensors, not shown in the figures, by means of which it can monitor for example the position of the apparatus 1, the intensity and the spectral composition of the emitted light, the air composition of the ambient air as well as the air within the treatment compartment of the apparatus 1, the condition and the growth of the plant 2, the time spent at different positions, the temperature outside and inside the treatment compartment, humidity outside and inside the treatment compartment. Via these sensors the above mentioned information is fed back to the control unit. Also the photosynthetic activity can be measured by means of photo luminance or by monitoring the oxygen production or carbon dioxide absorption. On the basis of the information collected by these different sensors, the control unit 5 controls the gas mixture and light levels to further optimize growing conditions. Apart from controlling growing conditions also the position of the apparatus has to be controlled. In order to monitor the position of the apparatus 1, the control unit 5 comprises a positioning system, either a global positioning system, GPS, or a local positioning system. In certain environments, especially indoors, GPS cannot be used and a local positioning system can provide an alternative thereto. A local positioning system can for example use Wi-Fi technology, Infrared light or Ultra wide band radio technology to determine the position of the apparatus.

A positioning system makes it possible to control treatment time as a function of the position and when equipped with appropriate storage means, the route of the apparatus 1 can be assessed and evaluated subsequently. While the control unit 5 certainly makes the apparatus 1 more or less automatic, it still has to be refueled from time to time, it is of course possible to program the motion and function of the apparatus 1 beforehand. It is also possible to remotely control the apparatus 1, either by an operator or by a separate, external guide unit not shown here. The latter can be of interest when a plurality of apparatuses are employed simultaneously. The external guide unit can receive and process the information collected by the separate apparatuses and guide them to the different spots that need treatment. In that way, treatment efficiency can be maximized and the time during which a sports field, or the like, cannot be used is held to a minimum.

The person skilled in the art realizes that the present invention by no means is limited to the preferred embodiments described above. On the contrary, many modifications and variations are possible within the scope of the appended claims. For example, the invention is by no means limited to the use of LEDs as light sources, mercury lamps, high-intensity discharge (HID) lamps, OLEDs, polymer LEDs may also be employed. Instead of using a DMFC as power source, Formic Acid Fuel Cells, Direct Ethanol Fuel Cells or fuel cells operating on formaldehyde can be used. Further, the apparatus does not necessarily have to be self propelled, it is also possible, within the scope defined by the appended claims, to provide an apparatus that is placed by an operator at positions where treatment is necessary.

1. An apparatus for influencing the growth of a plant, said apparatus comprising:
a mobile carnage,
a light source, and
a fuel cell, wherein the light source and the fuel cell are mounted to the mobile carriage and wherein the light source is driven by power produced by the fuel cell and wherein, in an operative state of the apparatus, light emitted by the light source and a reaction product from the fuel cell are directed towards the plant.

2. An apparatus according to claim 1, wherein a reaction product of the fuel cell is carbon dioxide.

3. An apparatus according to claim 1, wherein the light source comprises a light emitting diode.

4. An apparatus according to claim 1, wherein the fuel cell is selected from the group consisting of Direct Methanol Fuel Cell, Formic Acid Fuel Cell, Formaldehyde fuel cell and Ethanol Fuel Cell.

5. An apparatus according to claim 1, wherein the apparatus further comprises an electric drive system powered by the fuel cell and a steering device.

6. An apparatus according to claim 1, wherein further comprising a control unit.

7. An apparatus according to claim 6, wherein the control unit comprises a position indicator for determining the position of the apparatus.

8. An apparatus according to claim 7, wherein the position indicator comprises a global positioning system module.

9. An apparatus according to claim 7, wherein the position indicator comprises a local positioning module.

10. An apparatus according to claim 7, wherein the apparatus further comprises a skirt, wherein said skirt and an under side of the mobile carriage are arranged to enclose a plant to be influenced.

11. A method for influencing the growth of a plant , comprising: providing an apparatus comprising a mobile carriage having a light source and a fuel cell mounted thereon, wherein the light source is driven with power produced by the fuel cell; and directing the light emitted by the light source and a reaction product of the fuel cell towards the plant.

12. A method for influencing the growth of a plant according to claim 11, wherein a reaction product directed towards the plant is selected from the group consisting of carbon dioxide, heat and water.

13. A method for influencing the growth of a plant according to claim 11 wherein a skirt is provided to the apparatus, wherein said skirt and an under side of the mobile carriage encloses a plant to be influenced.

14. A method for influencing the growth of a plant according to claim 11, wherein oxygen is extracted from the plants environment.

15. A method for influencing the growth of a plant according to claim 11, wherein the levels of oxygen carbon dioxide and water vapour are controlled independently.
